(19) United States
(12) Patent Application Publication
(10) Pub. No.: US 2021/0195065 A1
(43) Pub. Date: Jun. 24, 2021

(54) METHOD OF DIGITAL IMAGES COLOR SEPARATION INTO TWO COLORED AND BLACK INKS FOR PRINTING WITH FOUR AND MORE INKS

(71) Applicant: PHYSICAL SCIENCE RESEARCH ASSOCIATES, INC., Colorado Springs, CO (US)

(72) Inventors: Anatolii Volodymyrovych Glushchenko, Colorado Springs, CO (US); Mykhajlo Vasylovych Shovhenyuk, Lviv (UA); Mariia Rudolfivna Semeniv, Lviv (UA); Bohdan Myhailovych Kovalskyi, Lviv (UA); Vasyl Gennadiiovych Nazarenko, Kiev (UA)

(21) Appl. No.: 16/755,168

(22) PCT Filed: Dec. 11, 2017
(86) PCT No.: PCT/UA2017/000120

§ 371 Date: Apr. 10, 2020

(30) Foreign Application Priority Data
Oct. 12, 2017 (UA) A 2017 09908

(51) Int. Cl. H04N 1/60

(52) U.S. Cl. CPC H04N 1/6022; H04N 1/6008

(57) ABSTRACT

A method of color separation of a digital image into two color and black inks for four or more color printing, in which an original digital image is converted into coordinates of an opponent color space of a print according to base vectors of a paper and of the colored inks, and vectors of the relative application of said inks to the print. In the opponent color space, the color coordinates of base vectors of the paired application of two adjacent colored inks are determined on a CaS chromaticity diagram of the color characteristics of N colored printing inks. The colors that fall in the color gamut of the printing inks are separated into N sectors each group of colors of the image of the original is separated into two colored inks, which correspond on the CaS chromaticity diagram to a selected sector of the colors of paired application of these inks, and a third black ink, and N color-separation image channels for the colored inks and a single common separated image channel for the black ink are formed for all of the colors of the image of the original.

### TECHNICAL FIELD

The invention relates to the methods of digital processing of color images for the color separation processes and reproduction of separate printing plates and can be used for printing of color digital images imprints on a paper by printing methods with four or more printing inks. The invention may also be used for creation of the color-coded data channels of the original image for digital printing with four or more colors and color printers printing.

### BACKGROUND OF THE INVENTION

Technological process of the image color separation to the color and black inks is the most difficult and responsible stage of pre-press preparation of printing plates. It's necessary during this process to take into account the actual color characteristics of the inks and the technological conditions of the printing process as much as possible, and to ensure the high quality of color reproduction on the imprint image of the original printing image.

There are known methods of printing and other kinds of paper image printing, which are based on the classic principle of the image colors synthesize by three colored inks—Cyan (C), Magenta (M), Yellow (Y) and fourth black (K) ink. This basic principle has remained unchanged for several centuries. The use of an additional black ink is necessary because of the fact that in the process of printing by three C, M, Y colored inks it is almost impossible to achieve high quality color reproduction at the imprint. It has been established on practice that with black ink adding to the printing process it is possible to correct some defects of real color inks on the imprint image. However, for the four-color printing, the CMYK, there is still an unresolved color separation problem. All modern color separating technologies without exception use the, so-called, standard CMYK profiles, which are based on the table values of colors, usually color coordinates (L*,a*,b*), which are synthesized on the imprint by different amount of printing inks.

The patent description [1] defines a system of color printing, known on practice as the PANTONE Hexachrome™ system of six colors—yellow (Y), orange (O), magenta (M), cyan (C), green (G) and black (K). This ink system allows to extend the color gamut in comparison with the classic CMYK ink system and, consequently, improve the color reproduction of the original image on the imprint.

The patent description [2] states a computerized system for color separation of a digital image for printing in six color inks—cyan (C), magenta (M), yellow (Y), red (R′), green (G′) and blue (B′). It is based on the use of standard ICC-profiles to convert the original RGB color data to CMYK database. Formation of data channels for additional inks R′, G′, B′ is carried out by combining of the two data channels of primary color inks C, M, Y and a part of data of the black ink. As a result, in the process of printing the black (K) ink is completely removed and replaced with additional inks R′, G′, B′.

The patent description [3] defines a method of image color separation into seven printing inks, including six colored inks: yellow (Y), orange (O), magenta (M), violet (V), cyan (C), green (G) and on extra—black (K). The essence of the color separation method based on that each color of the image is printed by four inks. The chromatic component of the selected color is printed with two adjacent colored inks, which are selected from the chromatic series of six color inks. Accordingly, the achromatic component of the color is printed by white ink, equivalent to the unprinted area of the white paper, and a black ink, which is determined by the difference between white color and the maximum value of one of the three basic colors R, G, B.

The disadvantage of these methods is that the printing of the four inks must be done in one layer, so there is no overlapping of the inks, and it is virtually impossible to achieve during the printing process. Moreover, the autotype process of color synthesis on paper by two colored inks, one of which corresponds to the additive colors of RGB, and the second—to the subtractive colors CMY, with the presence of the third black ink is much more complicated, and can't be explained on the basis of the RGB additive model.

The autotypical principle of the image synthesis on the imprint with colored inks is described by autotypical equations, which were proposed for the first time in 1935 by N. D. Nyberg (Nyberg N. D. Method of calculation of color separation in autotype three-color printing. Works of NII OGIZ. M.:1935; vol II, p. 173-183—in Russian) and later in 1937 by H. Neugebauer (Neugebauer HEJ. Die teoretischen Grundlagen des Mehrfarbendrucks. Zeitschrift fur wissenschaftliche Photographie, Photophysik und Photochemie. 1937. —Vol. 36, pp. 36-73). Analytical solutions of the autotypical Nyberg-Neigebauer equations have not been obtained so far, and for color separation applications CMYK profiles are used, which are based exclusively on the table data.

It is known method [4] for producing of the imprint using more than four inks, among which there are four main colors—Cyan (C), Magenta (M), Yellow (Y) and Black (K) and three additional colors—Red (R), Green (G) and Blue (B). The essence lays on the fact that for the profiles construction in the form of multidimensional color matching tables on the imprint, depending on the various combinations of the seven printing inks, all the inks are divided into four groups of colors—CMYK, MRYK, CGYK and CBMK, each of which contains three color inks and fourth black (K) ink. During the profile's construction of the four ink groups—CMYK, RMYK, CGYK and CMBK, they get a combined profile containing 4×164=4×65536=262144 colors table values of all combinations of four inks.

This method of the image separation into a color and black ink is based on the fact that each point (pixel) of a digital color image is printed only by four printing colors on a paper—three color and black (K), with the necessary combination of printing colors calculated from the profiles of only one group of inks—CMYK, MRYK, CGYK, or CBMK. The separation of all colors of the original image is achieved using the following methods: the GCR (Gray Component Replacement) method, which replaces the neutral gray components of the primary inks—cyan (C), magenta (M) and yellow (Y) with an equivalent black (K) ink; the Color Component Replacement (CCR) method, which replaces the color component of the two primary inks with an equivalent value of one additional ink—red (R), green (G) and blue (B).

This method of the image division into three color and black inks is follows.

A group of main colors is chosen as a base—cyan (C), magenta (M), yellow (Y) and black (K), which are used in the traditional four-color CMYK printing. For the basic group of CMYK colors the limit values of the chromaticity Cr₁ and Cr₂ are set. To print the original colors that characterized with the chromaticity Cr≤Cr₁ to provide optimum technological conditions for printing of the original colors, close to the neutral gray color group, the GCR method is used, with a constant coefficient of partial replacement of the neutral-gray component from the main CMY inks to the black color K, which is about 60%. For the original colors, which are characterized by the chromaticity of magnitude of Cr₁<Cr≤Cr₂, using the GCR method, the neutral-gray component coefficient increased to the full 100% replacement of the neutral-gray component of the main CMY inks to the black K ink proportional to the size of the Cr. To print saturated original colors that are characterized by the chromaticity of magnitude Cr>Cr₂, one of the basic colors C, M, or Y, is removed and the color division is performed based on the profiles of four colors groups CMYK, MRYK, CGYK, or CBMK.

The disadvantage of this method is that it is implemented on the classical principle of the 4 ink CMYK printing, regardless of the number of additionally selected ink groups. The task of determining the required combination of three color and black inks for synthesis of a given color F on paper is complex. In accordance, the method of constructing a profile of ink groups based on a table data database of 65,536 nodes of experimentally defined colors, which synthesize by different combinations of three color and black inks, is insufficiently precise and ineffective.

First, the table method of constructing a CMYK profile involves the use of a large number of nodal points of experimental colors, among which a large part is surplus data, due to the fact that the color separation problem of the image is multi-valued. In practice, much smaller nodal points of colors are used. Second, in order to use the GCR method with the partial replacement of the neutral gray components of the three color CMY inks to the black (K) ink in the CMYK profile, it is necessary to take into account not only the balance of the “pure” colored CMY inks, for which the condition of the balance is not implement on practice, but most of all, take into account the special role of the black ink in the process of replacing different amounts of neutral-gray components of colored CMY inks.

The second drawback is that the method of constructing profiles of seven-color printing is based on the table data of test imprints printed with four special CMYK inks and an expanded range of color gamut, which in the process of color separation of the image does not allow to take into account the technological conditions of multi-color printing and uniquely establish the necessary amount of four printing inks.

These disadvantages are solved in the method of the color separation of a digital image into two color and black inks for color printing with four or more colors, as previously described in the patent [5] and the international application [6], which is the prototype of the invention. This method of the color separation of the original image is based on the new principle: any arbitrary color of the original image synthesis only by two colored and black inks on the imprint, regardless of the number of color inks used in the process of color printing. Theoretically proved and experimentally confirmed that for each pixel of the original color image, there are exact solutions of the autotypical synthesis equations on the imprint, which establish the required minimum amount of two color and black inks for color printing.

The essence of this method color separation of a digital image into a colored and black inks for printing with four or more colors is that the color coordinates of the digital image are converted to the ICaS opponent color space of the imprint, in which all the colors of the original image are characterized by an achromatic coordinate I_{F} and two chromatic coordinates (C_{F},S_{F}), and which defines the color coordinates (Iₙ,Cₙ,Sₙ) of the base vectors of all color inks and the color coordinates (Iₙₘ,Cₙₘ,Sₙₘ) of the paired overlapping base vectors of the two adjacent n and m colored inks. On the chromatic CaS-diagram of N color printing inks, color characteristics all colors of the original image are divided into N sectors corresponding to the paired overlapping of the two adjacent n and m colored inks, each group of the original image colors is divided into two colored inks which are on the chromatic CaS-diagram corresponds to the selected color sector of paired overlapping of these inks and third black (K) ink and N channels of color separated images for colored inks. Also, common channel of the separated image for the black ink are formed. As a result, each pixel of the original digital image in the opponent color space of the imprint is separated only into three inks—two adjacent colored inks which on a chromatic CaS-diagram are determined by the chromatic coordinates (C_{F},S_{F}) of the original color, and in the process of printing, the color characteristics of the image on the imprint with a minimum amount of colored and third black (K) inks, which is determined by the achromatic coordinate I_{F} of the original color and forms the achromatic axis of the color gamut of the image on the imprint.

However, in this method, all colors of the original image must be part of the printing ink color gamut, used for color printing. If there are groups of colors in the original image that are beyond the range of color gamut, this method does not allow to reach them. In this case, it is necessary to perform an additional preliminary operation of color correction of the original image, which requires time and special software.

### SUMMARY OF THE INVENTION

The objective of the invention is to provide the possibility to cover all colors groups that within the range of the color gamut of inks for the original image, with an arbitrary number of color and black inks, and with a minimum number of table data of the ink's colors on a test imprint, using the analytical method of synthesizing a color image on the imprint.

This task is achieved by the fact that in a method of the colors separation of a digital image into two color and black inks for printing with four or more colors, which is based on the next principal: the color coordinates of a digital image are converted to the ICaS opponent color space of the imprint, in which all the colors of the original image are characterized by an achromatic coordinate I_{F} and two chromatic coordinates (C_{F},S_{F}) on the trial impression of the color coordinates (L*,a*,b*) on 2N fields of colored inks control scales, their paired overlapping, and separately the control scale of the black ink. Based on the measurements, the given color coordinates (Iₙ,Cₙ,Sₙ) of all the colored inks base vectors and the color coordinates (Iₙₘ,Cₙₘ,Sₙₘ) of the paired overlapping base vectors of the two adjacent n and m colored inks, as well as the numerical values of the colored inks nonlinearity coefficients γ_{C}, γ_{M}, γ_{Y} are determined, their mean value are chosen for the generalized parameter of the nonlinear transformation of color coordinates of the original into the opponent color space of the imprint, and the numerical values of the base vectors coordinates of all color inks and their paired overlapping got calculated. Then on the chromatic CaS-diagram of N color printing inks color characteristics all the colors of the original image are divided into N sectors corresponding to the paired overlapping of the two adjacent n and m colored inks and each pixel of the image got separated into two color and black inks based on the use of the color coordinates (Iₙ,Cₙ,Sₙ) of the printing colors inks values and color coordinates (Iₙₘ,Cₙₘ,Sₙₘ) of paired overlapping of two adjacent colored inks. So, if the F pixel's color of the digital image on the CaS-diagram is in the color sector, which is limited to the left by Hₙ color tone of the n-th ink, to the right by Hₘ color tone of the next m-th color, then this color is reproduced by the n-th and m-th inks, and the required amount σₙ and σₘ of two colored and σ_{K} of third black (K) inks for reproduction on the paper the color of the F selected pixel of the digital image is carried out by the method of analytical solution of the system of equations of autotypical synthesis:

$$\begin{matrix}{A}_{0} ( 1 - {σ}_{n} ) ( 1 - {σ}_{m} ) + {A}_{n} {σ}_{n} ( 1 - {σ}_{m} ) + {A}_{m} {σ}_{m} ( 1 - {σ}_{n} ) + {A}_{n m} {σ}_{n} {σ}_{m} = 0 \\ {B}_{0} ( 1 - {σ}_{n} ) ( 1 - {σ}_{m} ) + {B}_{m} {σ}_{n} ( 1 - {σ}_{m} ) + {B}_{m} {σ}_{m} ( 1 - {σ}_{n} ) + {B}_{n m} {σ}_{n} {σ}_{m} = 0\end{matrix} \}$$

in which constant coefficients

$${A}_{0} = det [ \begin{matrix}{I}_{F} & {I}_{W} \\ {C}_{F} & {C}_{W}\end{matrix} ] ; {A}_{n} = det [ \begin{matrix}{I}_{F} & {I}_{n} \\ {C}_{F} & {C}_{n}\end{matrix} ] ;$$

$${A}_{m} = det [ \begin{matrix}{I}_{F} & {I}_{m} \\ {C}_{F} & {C}_{m}\end{matrix} ] ; {A}_{n m} = det [ \begin{matrix}{I}_{F} & {I}_{n m} \\ {C}_{F} & {C}_{n m}\end{matrix} ] . \\ {B}_{0} = det [ \begin{matrix}{I}_{F} & {I}_{W} \\ {S}_{F} & {S}_{W}\end{matrix} ] ; {B}_{n} = det [ \begin{matrix}{I}_{F} & {I}_{n} \\ {S}_{F} & {S}_{n}\end{matrix} ] ;$$

$${B}_{m} = det [ \begin{matrix}{I}_{F} & {I}_{m} \\ {S}_{F} & {S}_{m}\end{matrix} ] ; {B}_{n m} = det [ \begin{matrix}{I}_{F} & {I}_{n m} \\ {S}_{F} & {S}_{n m}\end{matrix} ] .$$

are specified by the values of the 2×2 matrixes determinants, compiled from the color space ICaS coordinates, where the first column is given by the F color coordinates (index F), the second column is given by the coordinates of 4 base vectors, in particular, the paper (index W), two colored inks (indices n and m), and their mutual overlapping (index nm). The required amount σ_{K} of third black ink (K) for reproducing of the selected color F_{ICaS} is calculated by the size of the achromatic coordinate I_{F} of the original color using the formula:

$${σ}_{K} = \frac{{I}_{F}^{( 2 )} - {I}_{F}}{{I}_{F}^{( 2 )}}$$

which takes into account value of the achromatic component of the color F, and is formed by two adjacent colored inks,

I_{F}⁽²⁾=I_{W}(1−σₙ)(1−σₘ)+Iₙσₙ(1−σₘ)+Iₘσₘ(1−σₙ)+Iₙₘσₙσₘ

As a result of the original image color separation, N channels of color separated images for colored inks and common channel of the separated image for the black ink are formed. Each pixel of the original digital image in the opponent color space of the imprint is separated only into three inks—two adjacent colored inks which on a chromatic CaS-diagram are determined by the chromatic coordinates (C_{F},S_{F}) of the original color, and in the process of printing, the color characteristics of the image on the imprint with a minimum amount of colored and third black (K) inks, which is determined by the achromatic coordinate I_{F} of the original color and forms the achromatic axis of the color gamut of the image on the imprint. With the traditional four-color printing CMYK, in the process of the image separation into two color and black (K) inks, all colors F of the original image are divided into three groups according to their location at the sectors of paired overlapping of the two colored inks C+M, M+Y, and Y+C, respectively. In the first sector, which is limited by the lines of the cyan (C) and magenta (M) basic vectors, all the colors that form the blue region of the original image are taken, this color region is colorimetric precisely reproduced on the imprint by three inks—cyan (C), magenta (M) and black (K). In the second sector, which is bounded by the base vectors of the magenta (M) and yellow (Y) inks, similarly all the colors that form the red region of the original image are selected, this color region is colorimetric precisely reproduced on the imprint by three inks—magenta (M), yellow (Y) and black (K). In the third sector, which is bounded by the basic vectors of the yellow (Y) and cyan (C) inks, all colors that form the green region of the original image are selected, this color region is colorimetric precisely reproduced on the imprint by three inks—yellow (Y), cyan (C) and black (K).

According to the invention, in order to ensure that all tones of colors of the original image are part of the color gamut of the three-color printing—yellow (Y), magenta (M) and cyan (C), digital color image is converted to the coordinates (I_{F},C_{F},S_{F}) of the opponent color space of the imprint in the form of a decomposition to the base vectors F_{W} of paper, Fₙ of the colored inks and vectors Fₙₘ, Fₙₘₗ of their mutual overlapping on the imprint

$$F = ( 1 - {σ}_{K} ) \{ ( 1 - {σ}_{C} ) ( 1 - {σ}_{M} ) ( 1 - {σ}_{Y} ) {F}_{W} + {σ}_{C} {σ}_{M} {σ}_{Y} {F}_{CMY} + {σ}_{C} ( 1 - {σ}_{M} ) ( 1 - {σ}_{Y} ) {F}_{C} + ( 1 - {σ}_{C} ) {σ}_{M} ( 1 - {σ}_{Y} ) {F}_{M} + ( 1 - {σ}_{C} ) ( 1 - {σ}_{M} ) {σ}_{Y} {F}_{Y} + {σ}_{C} {σ}_{M} ( 1 - {σ}_{Y} ) {F}_{CM} + {σ}_{C} {σ}_{Y} ( 1 - {σ}_{M} ) {F}_{CY} + {σ}_{M} {σ}_{Y} ( 1 - {σ}_{C} ) {F}_{MY} \}$$

According to the invention, for the color separation process all the colors F of the original image are synthesized by analytical method based on the numerical values of the three inks vectors Fₙ coordinates and Fₙₘ, Fₙₘₗ vectors of their mutual overlays.

The advantage of the proposed method of color separation is the implementation of the effective method for expanding the color gamut of the primary colors CMYK by using additional colors—orange (O), green (G) and blue (B).

This method of color separation allows to increase the speed of the color separation process by using the minimum database of the color characteristics of printing inks, to improve the quality of color reproduction on the imprint based on the ability to print each point of the original image with only three inks, to save material resources and, most importantly, significant save colored inks.

Also, in the proposed method usage of analytical method of synthesizing a color image on the imprint allows to cover all colors groups of the original image, which are beyond the range of color gamut of the inks.

### BRIEF DESCRIPTION OF THE DRAWINGS

FIG. 1 shows a schematic of linearly converting of color coordinates from RGB color space to the ICaS opponent color space and CaS-diagram of colors;

FIG. 2 is a diagram of the nonlinear transformation of color coordinates from the color space of the original image to the color space of the imprint;

FIG. 3 illustrates the limiting cases of using the GCR method;

FIG. 4 shows the CaS-diagram of CMYK printing inks according to Fogra 39;

FIG. 5 is an algorithm of the image separation into two colored and black (K) inks with four-color printing CMYK;

FIG. 6—CaS-diagram of the PANTONE Hexachrome printing ink system;

FIG. 7 is a flow chart for the image separation into two colored and black (K) inks for the general case of seven-color printing;

FIG. 8—examples of the test image separation into two colored inks C+M, M+Y, Y+C (8a); and black (K) ink (8b); with four-color printing CMYK;

FIG. 9 shows the results of a comparative analysis of the color and black ink usage in the traditional and proposed method of the test image separation on the FIG. 8.

### DETAILED DESCRIPTION OF THE EMBODIMENTS

In the proposed method, the principle of reproducing on the paper an arbitrary color F of the original image, which is included into the area of color gamut of printing colored inks in two color and black inks established. Choosing this principle allows to solve the main task of color separation in a new way—uniquely determine the required minimum amount of colors to reproduce an arbitrary color F. The solution to this problem follows.

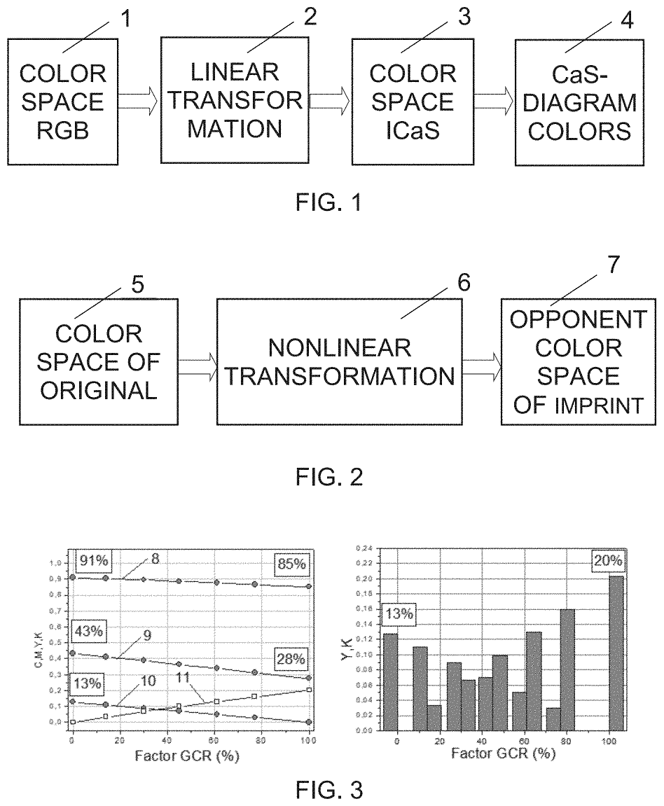

The digital original image contains all the necessary color information: in a given RGB color space, where the color separation of the original image is carried out: each pixel is characterized by the numerical values of the color coordinates R, G, B. These coordinates are uniquely linked to the International Color System CIE Lab. To characterize the colors of the original image in the process of separation into two color and black inks, the transition to the opponent color space of the imprint is based on the use of the new color space, which we called ICaS. As shown on FIG. 1, the transition from the color space RGB 1 to the color space ICaS 3 is carried out as a result of linear transformation of 2 color coordinates of the original image, which is described by a linear matrix equation of the form:

$$[ \begin{matrix}{I}_{F} \\ {C}_{F} \\ {S}_{F}\end{matrix} ] = \frac{1}{\sqrt{3}} [ \begin{matrix}1 & 1 & 1 \\ 1 & cas ( 2 π / 3 ) & cas ( 4 π / 3 ) \\ 1 & cas ( 4 π / 3 ) & cas ( 2 π / 3 )\end{matrix} ] [ \begin{matrix}R \\ G \\ B\end{matrix} ] \qquad ( 1 )$$

where the transition matrix is the orthogonal, normalized, and symmetric Hartley matrix 3×3, whose elements are determined by the function cas(x)=cos(x)+sin(x) (Hartley's transformation is described in the book—Bracewell R. N. The Hartley Transform. Oxford University Press, Inc. 1986). The direct transformation (1) of the color data and the corresponding inverse transformation are described by the same Hartley matrix.

The fundamental advantage of using the ICaS color space is that three new coordinates are used to characterize and quantify the colors of the original image: an achromatic coordinate I_{F} and two chromatic coordinates C_{F} and S_{F}. The achromatic coordinate I_{F} uniquely and completely characterizes the neutral-gray colors of the original image. For arbitrarily chosen colors Fᵢ(Rᵢ,Gᵢ,Bᵢ), the chromatic coordinates (C_{F},S_{F}) on plane 4, which we will call the chromatic CaS-color diagram, uniquely and fully describe its color characteristics: chromaticity (Chroma) Crᵢ=(Cᵢ²+Sᵢ²)^{1/2} color tone (Hue) Hᵢ=θᵢ, cos θᵢ=Cᵢ/(Cᵢ²+Sᵢ²)^{1/2}.

Different color spaces known today—HSI, YUV, YIQ, YCrCb, YES, Kodak Photo YCC, etc., are converted by linear transformation into canonical ICaS color space. Thus, a simple and controlled representation of colors on the chromatic CaS-color diagram allows a significant simplification of the conditions for quantitative analysis of the digital image colors, which is essential for the digital processing of colored originals for printing at the stage of color separation.

In the ICaS color space, the achromatic coordinate I of the arbitrary color F_{ICaS} of the digital image corresponds to the imprint of the black (K) ink. Thus, regardless of the number of N color printing inks, the ICaS color space achieves the complete separation of the black (K) ink from the remaining N colored inks.

Possibility of full black color separation among the remaining N colored inks gives reasons for considering it as the main factor of the achromatic component formation of the digital image colors during the process of color separation. In traditional methods of color separation, on the contrary, the black ink is considered as an additional factor that only extends the range of the image achromatic colors and partially compensates the gray component of the three primary CMY inks.

To determine the values of the printing inks base vectors test printouts of 2N+1 control scales are printed. The color coordinates (L*,a*,b*) of each field of control scales are measured on test prints. Based on these data, the printing inks color coordinates of the RGB color space are calculated, on which the digital processing of the original image is performed. Received color coordinates are used to determine the coefficients of non-linearity of printing inks.

Based on the obtained values of each color ink coefficients of nonlinearity: γ_{C}—for cyan ink, γ_{M}—for magenta ink, and γ_{Y}—for yellow ink, the average value of the coefficient of nonlinearity γ_{CMY}=(γ_{C}+γ_{M}+γ_{Y})/3 is determined, which characterizes the technological conditions of printing with all inks. Table 1 shows the numerical values of coefficients of nonlinearity for colored inks of standardized ICC-profiles that correspond to the technological conditions of the offset printing.

TABLE 1

| | | | Screen, | | | | |
|---|---|---|---|---|---|---|---|
| Data | Profile | Paper | lines/cm | γ_{C} | γ_{M} | γ_{Y} | γ_{CMY} |
| FOGRA 39 | ISO Coated | Type1, 2 | 60 | 1,481 | 1,525 | 1,515 | 1,507 |
| FOGRA 28 | ISO Web | Type 3 | 60 | 1,602 | 1,672 | 1,636 | 1,637 |
| | Coated | | | | | | |

Analyzing the resulted data, we can conclude that the coefficient of nonlinearity depends on the paper type. For coated paper (type 1 and 2), the value of the coefficient is less than for web paper (type 3). The magnitude of the coefficient also depends on the linearity of the screen, the method of screening (AM-screening, or FM-screening), the type of printing (negative or positive), printing machine, and so on. Smaller the value of the coefficient, better the print conditions of the color image. Thus, the magnitude of the coefficient is chosen as a generalized parameter for characterization of the qualitative indices of the image color reproduction during real printing conditions.

To take into account the technological conditions of printing during the process of color separation of a digital image into two color and black (K) inks, it's proceeded from the color space of the original 5 to the color space of the imprint 7, the schematics of which is shown on FIG. 2. The image of a digital original is always associated with a specific RGB color space, which is characterized by the specified value of the coefficient of nonlinearity γ_{RGB}. For most of the color spaces RGB value γ_{RGB}=2,2. Then, the nonlinear transformation of 6 color coordinates of each digital original image pixel in FIG. 3 describes by the exponential function with the exponent index γ₁=γ_{RGB}/γ_{C}. As a result, new color coordinates (R₁,G₁,B₁) of the digital image in the color space RGB of the imprint are obtained, which characterizes the process of printing inks colors synthesis.

After statistical processing of the measurement results on the test prints, 140 fields of control scales obtained, R₁,G₁,B₁ coordinates of all CMYK inks base vectors, and R₁,G₁,B₁ coordinates of the overlapping of two adjacent colored inks base vectors (C+M, M+Y and Y+C, respectively) on the color space of the imprint. For the resulting numerical values (R₁,G₁,B₁) of the base vector's coordinates based on formula (1) the corresponding basic vectors coordinates of the printing inks are calculated. Thus, according to the scheme on FIG. 1, the transfer to the opponent color space of an imprint is carried out, and the base vectors of all colored inks are determined.

At the initial stage of the color separation process, the original digital image is converted into coordinates of the opponent color space in the form of expansion:

$$F = ( 1 - {σ}_{K} ) \{ ( 1 - {σ}_{C} ) ( 1 - {σ}_{M} ) ( 1 - {σ}_{Y} ) {F}_{W} + {σ}_{C} {σ}_{M} {σ}_{Y} {F}_{CMY} + {σ}_{C} ( 1 - {σ}_{M} ) ( 1 - {σ}_{Y} ) {F}_{C} + ( 1 - {σ}_{C} ) {σ}_{M} ( 1 - {σ}_{Y} ) {F}_{M} + ( 1 - {σ}_{C} ) ( 1 - {σ}_{M} ) {σ}_{Y} {F}_{Y} + {σ}_{C} {σ}_{M} ( 1 - {σ}_{Y} ) {F}_{CM} + {σ}_{C} {σ}_{Y} ( 1 - {σ}_{M} ) {F}_{CY} + {σ}_{M} {σ}_{Y} ( 1 - {σ}_{C} ) {F}_{MY} \} \qquad ( 2 )$$

with respect to the basic vectors F_{W} of the paper, Fₙ of the color inks and vectors Fₙₘ and Fₙₘₗ of their mutual overlapping on the imprint. In this form, an analytical method is used to synthesize the original image on the imprint for traditional color printing methods with three colored inks, in which all colors F(I_{F},C_{F},S_{F}) will be included in the color gamut of the colored inks.

For example, FIG. 3 shows the case of color F reproduction, which in the ICaS color space has color coordinates: I_{F}=0.5885; C_{F}=−0.2841; S_{F}=−0.0702. Based on the numerical solution of the autotypical Nyberg-Neigebauer equations, this color is reproduced on the paper by three colored inks: σ_{C}=91%; σ_{M}=43%; σ_{Y}=13%. Taking into account the minimum amount of the yellow ink σ_{Y}, usage of the GCR method allows to replace the part of the neutral-gray components of the CMY inks with a black (K) ink. Depending on the percentage part of the substitution (GCR factor) based on equation (2), a number of different colors combinations are obtained: σ_{C}—curve 8, σ_{M}—curve 9, σ_{Y}—curve 10, σ_{K}—curve 11, which can synthesize the same color F. It gives reasons to state that the selected color F of the original image is reproduced colorimetric accurately by different combinations of CMYK inks.

The only way to simplify the color separation problem is to completely replace one yellow (Y) ink with a black (K) ink (FIG. 3 on the right). The accuracy of this method is confirmed by the fact that usage of the GCR method clearly shows the general tendency: an increase in the percentage of the neutral-gray component of the CMY primary colors to the black (K) ink, the reduction of the total area coverage (TAC) of all printing inks on the imprint. In the extreme case, the complete replacement of the yellow (Y) ink to the black (K) ink is done using a simpler three-color model for the color of the imprint and, moreover, achieving a colorimetric accurate reproduction of color F on a paper with a minimum number of two colored and third black inks: σ_{C}=85%; α_{M}=28%; σ_{K}=20%. Compared to colored CMY, the total area of the TAC of three-color CMK is reduced by 14%. It is important to note that theoretically the TAC limit value of 300% characterizes only one point of maximal black color.

The process of color separation of a digital image is conceded in the following way. The entire range of neutral-gray colors of the image is printed with only black ink. To reproduce all colors of a digital image that are part of the color range of N color printing inks on the paper, two adjacent colored inks are enough in addition to black ink. Thus, in the process of color separation, each pixel of a digital image is divided only into three inks: a black (K) ink that forms the achromatic (vertical) axis of the color gamut of the image and two adjacent colored inks, which form a color characteristic of the image on the chromatic CaS-diagram.

Determination of the required amount of two colored inks to reproduce the digital image pixel of the selected color F on a paper is done analytically. The choice of colored inks proceeds as following.

If the color F_{ICaS} of the digital image pixel on the chromatic CaS diagram is found in the color sector, which is limited to the left by color tone Hₙ of the n-th ink and to the right by the color tone Hₘ of the m-adjacent ink, then this color clearly will be reproduce by the n-th and m-th inks. Necessary amount σₙ and σₘ of the inks are found from the system of two quadratic autotypical equations:

$$\begin{matrix}{A}_{0} ( 1 - {σ}_{n} ) ( 1 - {σ}_{m} ) + {A}_{n} {σ}_{n} ( 1 - {σ}_{m} ) + {A}_{m} {σ}_{m} ( 1 - {σ}_{n} ) + {A}_{n m} {σ}_{n} {σ}_{m} = 0 \\ {B}_{0} ( 1 - {σ}_{n} ) ( 1 - {σ}_{m} ) + {B}_{m} {σ}_{n} ( 1 - {σ}_{m} ) + {B}_{m} {σ}_{m} ( 1 - {σ}_{n} ) + {B}_{n m} {σ}_{n} {σ}_{m} = 0\end{matrix} \} \qquad ( 3 )$$

In this system of the equations constant coefficients are:

$$\begin{matrix}{A}_{0} = det [ \begin{matrix}{I}_{F} & {I}_{W} \\ {C}_{F} & {C}_{W}\end{matrix} ] ; {A}_{n} = det [ \begin{matrix}{I}_{F} & {I}_{n} \\ {C}_{F} & {C}_{n}\end{matrix} ] ; \\ {A}_{m} = det [ \begin{matrix}{I}_{F} & {I}_{m} \\ {C}_{F} & {C}_{m}\end{matrix} ] ; {A}_{n m} = det [ \begin{matrix}{I}_{F} & {I}_{n m} \\ {C}_{F} & {C}_{n m}\end{matrix} ] . & ( 3 a ) \\ {B}_{0} = det [ \begin{matrix}{I}_{F} & {I}_{W} \\ {S}_{F} & {S}_{W}\end{matrix} ] ; {B}_{n} = det [ \begin{matrix}{I}_{F} & {I}_{n} \\ {S}_{F} & {S}_{n}\end{matrix} ] ; \\ {B}_{m} = det [ \begin{matrix}{I}_{F} & {I}_{m} \\ {S}_{F} & {S}_{m}\end{matrix} ] ; {B}_{n m} = det [ \begin{matrix}{I}_{F} & {I}_{n m} \\ {S}_{F} & {S}_{n m}\end{matrix} ] . & ( 3 b )\end{matrix}$$

They are specified by the values of the matrixes 2×2 determinants, compiled from the coordinates of the ICaS opponent color space: the first column is given by the coordinates of the original color F_{ICaS} (F index), and the second column is given by the coordinates of 4 base vectors: of the paper (index W), of the two adjacent colored inks (indices n and m) and of their mutual overlapping (index nm).

The obtained real solution σₙ and σₘ of the system of equations (3) allows to determine the value of the achromatic component of the color F, which forms two adjacent colored inks,

I_{F}⁽²⁾=I_{W}(1−σₙ)(1−σₘ)+Iₙσₙ(1−σₘ)+Iₘσₘ(1−σₙ)+Iₙₘσₙσₘ (4)

Then the required amount σ_{K} of the third black (K) ink to reproduce the selected color F_{ICaS} is calculated by the value of the achromatic coordinate I_{F} of the original color based on the formula:

$${σ}_{K} = \frac{{I}_{F}^{( 2 )} - {I}_{F}}{{I}_{F}^{( 2 )}} \qquad ( 5 )$$

The advantage of the analytical method is that for the solution of the color separation problem, the minimum number of base vectors of colored inks is used: for 3 inks—6 base vectors, for 4 inks—8 base vectors; for 5 inks-10 base vectors, etc. Thus, for the solution of the color separation problem of the original image to the N color and black (K) printing inks data for 2N+1 base vectors are enough.

The method of separating the image into two color and black (K) inks is the most optimal way of solving the color separation problem. First, such a statement of the problem of color separation has a unique solution, which allows to use effectively numerical methods for determining the required amount of three inks. When using the traditional method of separating the image color into three color and black (K) inks, the solution of the color separation problem is significantly more complicated. The system of autotypical equations (3) is transformed into a system of cubic equations, which have many solutions. Therefore, numerical methods for determining the required amount of 4 inks become ineffective. It involves necessity of usage of a large number of reference colors table values on test prints, which are synthesized by various combinations of 4 printing inks. Secondly, the method of color separation of the image into two color and black (K) inks provides the usage of the minimum number of colors needed to print each pixel of the image. At the same time, optimum technological conditions of N-ink printing are achieved, with significant savings of the colored printing inks.

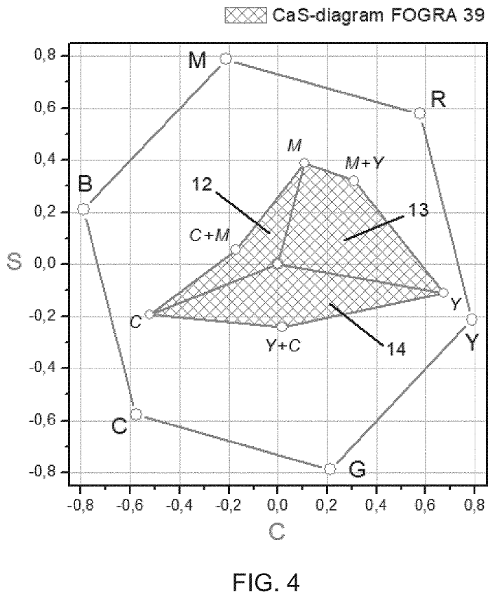

FIG. 4 shows the CaS-diagram of CMYK printing inks for offset printing on coated paper type 1 and 2 according to FOGRA 39. Table 2 shows the numerical values of the base vectors of printing inks in the ICaS opponent color space.

TABLE 2

| Inks and their | Color coordinates | | |
|---|---|---|---|
| overlapping | Iₙ | Cₙ | Sₙ |
| Cyan, C | 0.712 | −0.510 | −0.202 |
| C + M | 0.314 | −0.193 | 0.059 |
| Magenta, M | 0.566 | 0.116 | 0.418 |
| M + Y | 0.430 | 0.324 | 0.335 |
| Yellow, Y | 1.045 | 0.684 | −0.108 |
| Y + C | 0.391 | 0.013 | −0.252 |
| C + M + Y | 0.195 | 0.003 | 0 |
| Black, K | 0.131 | 0.002 | 0 |
| Paper, W | 1.608 | 0 | 0 |

The method of color separation of a digital image into two color and black inks in the opponent color space of the imprint based on the following principals.

By scanning the original digital image and recalculating its color coordinates into the opponent color space of the imprint, all colors of the original image, which are included in the color gamut of printing inks, are divided into three sectors on the chromatic CaS-diagram. In the first sector 12, which is bounded by the lines of the base vectors of cyan (C) and magenta (M) inks, all colors which form the blue color region of the original image are selected. This color gamut is colorimetric accurately reproduced on the imprint by three—Cyan (C), Magenta (M) and Black (K) inks. Similarly, in the second sector 13, which is bounded by the lines of the base vectors of magenta (M) and yellow (Y) inks, all colors that form the red color region of the original image will be selected. This color gamut is accurately reproduced on the imprint by three—Magenta (M), Yellow (Y) and Black (K) inks. Finally, in the third sector 14, which is bounded by the lines of the base vectors of yellow (Y) and cyan (C) inks, all colors that form the green color region of the original image will be selected. This color gamut is accurately reproduced on the imprint by three—Yellow (Y), Cyan (C) and Black (K) inks.

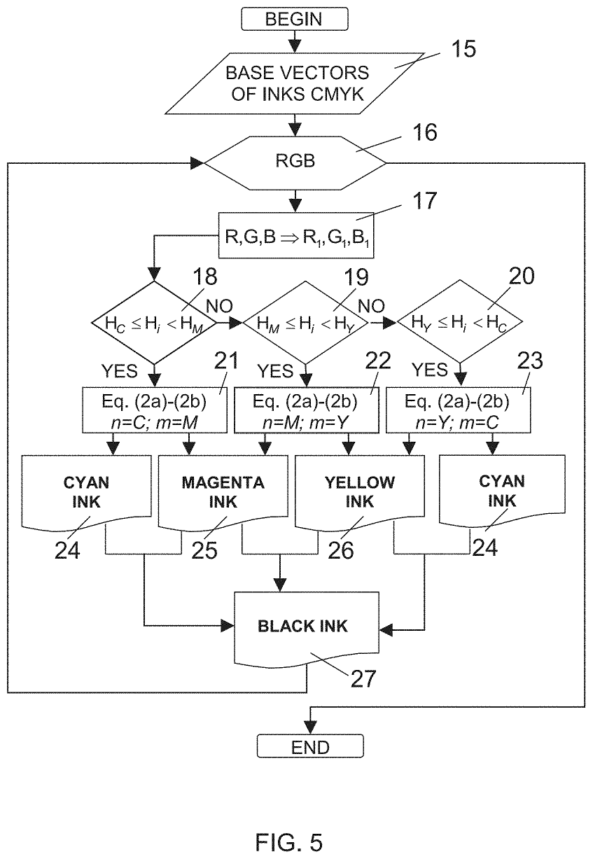

The method of the image color separation into two colored and black (K) inks in a traditional four-color CMYK printing is described by the algorithm showed on FIG. 5. In the block 15, the numerical values of the printing inks base vectors—C, M, Y, K and the paired overlapping—C+M, M+Y, Y+C are introduced. Block 16 indicates the formation of the reading cycle of the color coordinates (R,G,B) of the each pixel of original digital image. In block 17, according to FIG. 5, the transition from the color space of the original image to the opponent color space of the imprint is carried out.

For the color space of the imprint, a CaS-diagram of printing inks is build. Then the color coordinates of the i-th color Fᵢ, which are read from each pixel of the original image, correspond to the new coordinates of the same color in the opponent color space of the imprint.

For the i-th color Fᵢ the value of the color tone is determined. In blocks (18)-(20), the value of color tone H is checked for the conditions of matching to the i-th color Fᵢ to one of the three color tone regions on the CaS-diagram, which are shown on FIG. 4 under numbers 12, 13 and 14, respectively. Thus, in the ICaS color space, by the matching conditions of the color tone Hᵢ, all the colors F of the original digital image are separated into three sectors corresponding to the paired overlapping of the printing inks C+M, M+Y and C+Y, respectively.

To determine by the analytical method the required amount of two colored inks, a single system of two quadratic autotypical equations (2) with different constant coefficients (2a)-(2b) is used.

For the color group of the first sector 12 in block 21, the base vectors coordinates for cyan (C), magenta (M) inks and their paired overlapping are selected; for the second sector 13 in block 22, the base vectors coordinates of the magenta (M), yellow (Y) inks and their paired overlapping are chosen; for the third sector 14 in block 23, the base vectors coordinates of the yellow (Y), cyan (C) inks and their paired overlapping are chosen.

After obtaining solutions for three systems of autotypical equations for all colors of the original digital image, three channels of color separated images are formed: channel 24 for a cyan (C) ink; channel 25 for a magenta (M) ink; channel 26 for a yellow (Y) ink. For each pair of colored inks, based on the equations (4) and (2), a common channel 27 of black ink is formed.

The described method of the image colors CaS-diagram constructing allows us to solve the problem of separation of the image colors into two color and black inks as a result of expanding the area of the color gamut of printing inks by using additional color inks. If in the sector of the n-th and m-th main color inks, which are characterized by the color tones Hₙ and Hₘ respectively, the presence of the third j-th additional color ink with a color tone Hⱼ, which is on the chromatic color CaS-diagram occupying the position between the adjacent n-th and m-the main inks, this sector will be divided into two new sectors—the n-th main and j-th additional color inks sector, and the j-th additional and m-th main color inks. Thus, each new additional ink will form a new additional sector.

In the general case of the color separation of a digital image into N color printing inks creates N sectors of adjacent colored inks, regardless of which colors are considered base, and which are additional.

Let's describe in more detail the method of separation a digital image colors into two color and black inks for the general case of expanding the color coverage of the primary CMYK inks by using additional colors—orange (O) and green (G).

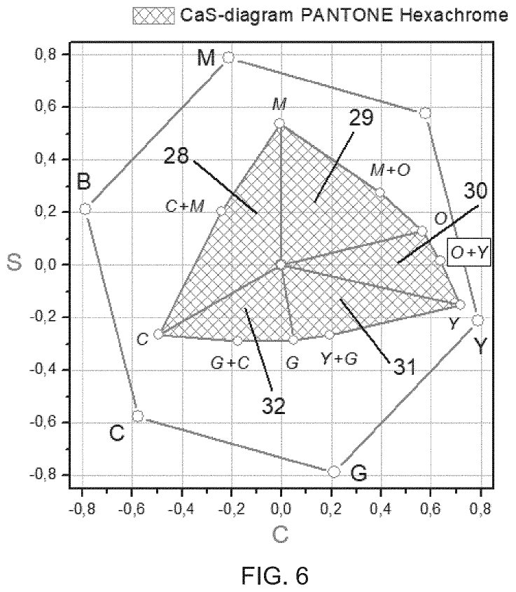

For an example, FIG. 6 shows the color CaS-diagram of the PANTONE Hexachrome printing ink system in the opponent color space of the imprint. In sector 28, all the colors F of the digital image are divided into cyan (C) and magenta (M) inks. In this case, we have an analogy with the sector 12 of the CMYK ink system, with the only difference that the base vectors of the cyan (C) and magenta (M) inks of the PANTONE HEXACHROME system are different. However, the second sector 13 (FIG. 4) on the CaS-diagram of FIG. 6 are divided into two new sectors. In the sector 29 adjacent ones are magenta (M) and orange (O) colored inks, and in the next sector 30 adjacent are the next pair—orange (O) and yellow (Y) colored inks. Thus, the colors of the digital image of the sector 29 are colorimetric accurately reproduced on the imprint with magenta (M) and orange (O) inks, and from the sector 30—by the orange (O) and yellow (Y) inks. Similarly, the third sector 14 (FIG. 4) on the CaS-diagram of FIG. 6 is also divided into two new sectors. In the sector 31 adjacent ones are yellow (Y) and green (G) colored inks, and in the next sector 32 adjacent are the next pair of green (G) and cyan (C) colored inks. Accordingly, the colors of the digital image of sector 31 are colorimetric accurately reproduced on the imprint by yellow (Y) and green (G) inks, and from the sector 32—by green (G) and cyan (C) inks. As a result, the sequence of the neighboring color inks of the PANTONE Hexachrome system shown in the color CaS-diagram is characterized by a greater color gamut than the CMYK ink system.

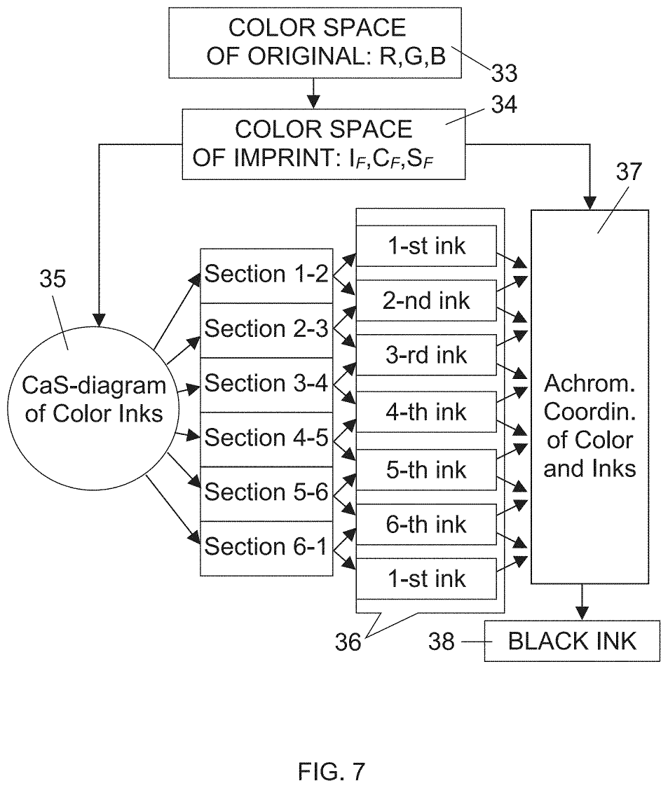

For the practical realization of the described method of a digital image color separation a special computer program was created. Input data of the program are: number N+K, where N is the number of colored inks; numerical values of 2N base vectors of color inks and paired overlapping of adjacent colored inks and numerical values of the base vectors of black (K) ink and paper (W); a numerical value γ_{Color-Inks} that characterizes the technological conditions for the future printing of color images on the paper. We will describe in detail the method of computer color separation of the image for the most common practical case of seven-color printing (6 color inks and black (K) ink), the block diagram of which is shown on FIG. 7

The original digital color image, which is a subject to the color separation, is entered into the computer program and displayed on the monitor screen. In block 33, the original image is scanned. The resulting numerical values of the color coordinates R,G,B of each pixel of the original image are recalculated taking into account the magnitude of the coefficient of nonlinearity γ_{Color-Inks} in the new color coordinates R₁,G₁,B₁ of the digital image in the color space of the imprint. In block 34, the color coordinates of the original image in the ICaS color space of the imprint are calculated.

Block 35 contains a database of CaS-diagrams of colored printing inks, formed on the basis of numerical values of 2N base vectors of color inks and the paired overlapping of adjacent colored inks. Based on the obtained values of the chromatic coordinates (C_{F},S_{F}) of each pixel, in Block 35 are carried out the separation of the original image color into the corresponding sectors of two adjacent colored inks, by the criterion of the value of the color tone Hᵢ. Thus, in an automatic mode, the separation of all colors of the original image into N sectors of two adjacent colored inks is achieved. For the color group of the original image, based on formulas (3a)-(3b), the required quantity σₙ and σₘ of colored inks that will be printed on paper is calculated using the analytical method in each sector. Thus, based on the calculation results of each sector, the required amount of two adjacent colored inks in block 36 will form single color separations for all 6 color inks.

In the described method, the digital color separation of a digital image by a more complex algorithm implements the process of forming a single separated image of a black (K) ink, since this ink is necessary for all of the colors of the original image without the exception and accordingly present in all six sectors of colors of two adjacent colored inks as mandatory third ink. This process in block 37 is carried out in two steps. First, based on the set quantities σₙ and σₘ of two adjacent colored inks, which take part in the reproduction on the paper of each individual pixel of the original image, and the values of the achromatic coordinates of these inks and their paired overlapping, based on the formula (4) the value of the achromatic component I_{F}⁽²⁾ of the i-th pixel color, which will be formed by two colored inks, is calculated. On the other hand, due to the third black (K) ink, it is necessary to reach the value I_{F} of the achromatic coordinate of the i-th original pixel color. Hence, based on the formula (4), the required amount σ_{K} of the third black ink is determined, which balances the achromatic component I_{F}⁽²⁾ of the two-colored image to the level of the achromatic color coordinate of the original image and as a result, in the block 38, a black ink image is formed that is common to all six-colored images.

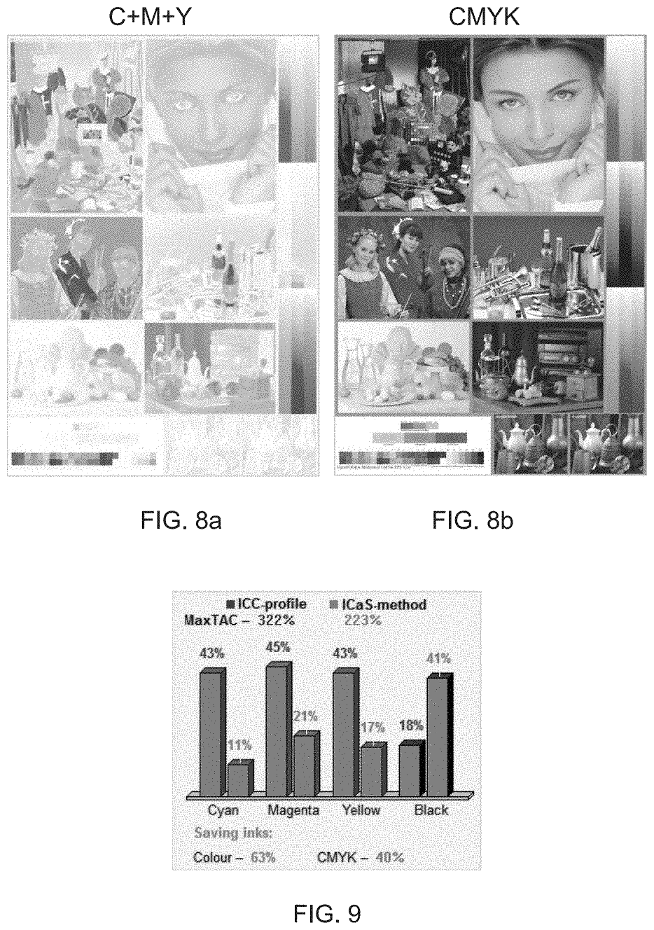

FIG. 8 is an example of the implementation of the method of computer color separation of the digital image for four-color CMYK printing. The original digital image, which is shown on FIG. 8a, separated by a computer program, and each pixel of the original image is printed with only 2 adjacent colored inks—C+M, M+Y, Y+C. The more striking feature of the CMY color image is that the imprint forms bright and the most saturated colors of the original image, which include a wide range of color tones that can be achieved on paper by the different quantities of paired overlapping of two adjacent colored inks. With respect to brightness and color saturation, the claimed method of color separation has no analogue with the traditional CMY three-color printing method or other known ink systems in which various versions of three-color printing are implemented. At the same time, compared to the original image, the color CMY image is significantly different, it is visually perceived as a “flat” and unreal image. This is explained by the fact that in the color separation process only the colors that are located exclusively on the surface of the three-dimensional color body of the original image are characterized and their color characteristics are selected.

In the process of printing of the image of a black (K) ink on the CMY color printing (FIG. 8b), a unique black color effect was observed in the presence of different colors: due to one black ink, which only performs the redistribution of the achromatic component of the colors of the colored inks in accordance with the achromatic color coordinates of the original image, an incredible result is achieved when the prints are like all the colors of the original image “come alive”.

FIG. 9 presents the results of a comparative analysis of the usage of color and black inks in the traditional and new methods of color separation of the test image on FIG. 8. As it can be seen, the use of a new color separation principle in two color and black inks for all printing inks achieves significant savings in colored inks, which, in contrast to the traditional color printing method, complies with the European standard, saves 63% of colored inks. Despite the fact that the new method uses a larger amount of black ink, the overall savings of all inks is 40%.

It's important to note that for a standard ICC-profile, the maximum TAC value for overlapping of all inks in dark areas of the image on the imprint is 322%. The new ICaS-Color separation method allows you to significantly reduce the maximum permissible TAC to 223%, which characterizes the “ideal” color printing conditions that exceed the requirements of print standards.

### INFORMATION SOURCES

1. U.S. Pat. No. 5,734,800. Six-color process system//Herbert R., Dibemardo A. Int. Cl.: H04N 1/54. Pub. Date: Mar. 31, 1998
2. U.S. Pat. No. 8,064,112. Color separation and reproduction method for controlling a printing process//Bernasconi M. J. Int. Cl.: H04N 1/04. Pub. Date: Nov. 22, 2011
3. U.S. Pat. No. 4,812,899. A printing process, where in each incremental area is divided into a chromatic area and an achromatic region, and wherein the achromatic areas are printed in black and white, and the chromatic areas are printed in color sections//Kueppers H. Int. Cl.: H04N 1/54. Pub. Date: Mar. 14, 1989
4. Patent DE102004003300. Verfahren zur Herstellung eines Prüfdrucks für einen Druckprozess mit mehr als vier Druckfarben//Bestmann G. Int. Cl.: H04N 1/60. Pub. Date: Aug. 25, 2005
5. Patent Ukraine 105961. Method of separating the colors of a digital image into two color and black inks for printing with four or more colors//Shovgenyuk M. V. Int. Cl.: B41J 2/21; H04N 1/50. Pub. Date: Oct. 7, 2014
6. Application WO2014088525. The method of separating the colors of a digital image into two color and black paints for printing with four or more inks//Shovgenyuk MV Int. Cl.: H04N 1/60; H04N 9/75; G06K 15/00. Pub. Date: Jun. 12, 2014.

What is claimed is:

1. The method of the color separation of a digital image into two color and black inks for printing with four or more inks, which includes such processes:
transformation of the original digital image into coordinates of an ICaS opponent color space of the imprint;
synthesis by analytical method of all colors F of the original image on the basis of numerical values of three inks vectors Fₙ and their mutual overlapping vectors Fₙₘ, Fₙₘₗ;
paired overlapping and single black ink control scale;
definition on the basis of measurements the given color coordinates (Iₙ,Cₙ,Sₙ) of all the colored inks base vectors and the color coordinates (Iₙₘ,Cₙₘ,Sₙₘ) of the paired overlapping base vectors of the two adjacent n and m colored inks, as well as the numerical values of the colored inks nonlinearity coefficients γ_{C}, γ_{M}, γ_{Y}.
Selection of the mean value as the generalized parameter of the nonlinear transformation of original color coordinates into the opponent color space of the imprint;
calculation of the numerical values of the base vectors coordinates of all color inks and their paired overlapping;
separation on the chromatic CaS-diagram of N color printing inks color characteristics all the colors of the original image into N sectors corresponding to the paired overlapping of the two adjacent n-th and m-th colored inks;
color separation of each pixel of the image into two color and black inks based on the use of the color coordinates (Iₙ,Cₙ,Sₙ) of the printing colors inks values and color coordinates (Iₙₘ,Cₙₘ,Sₙₘ) of paired overlapping of two adjacent colored inks;
reproduction of the pixel's F color of the digital image on the CaS-diagram in the color sector, which is limited to the left by Hₙ color tone of the n-th ink, to the right by Hₘ color tone of the next m-th ink, by the n-th and m-th inks;
the required amount σₙ and σₘ of two colored and σ_{K} of third black (K) inks for reproduction on the paper of the F selected pixel color of the digital image is carried out by the method of analytical solution of the system of equations of auto-typical synthesis:
$$\begin{matrix}{A}_{0} ( 1 - {σ}_{n} ) ( 1 - {σ}_{m} ) + {A}_{n} {σ}_{n} ( 1 - {σ}_{m} ) + {A}_{m} {σ}_{m} ( 1 - {σ}_{n} ) + {A}_{n m} {σ}_{n} {σ}_{m} = 0 \\ {B}_{0} ( 1 - {σ}_{n} ) ( 1 - {σ}_{m} ) + {B}_{m} {σ}_{n} ( 1 - {σ}_{m} ) + {B}_{m} {σ}_{m} ( 1 - {σ}_{n} ) + {B}_{n m} {σ}_{n} {σ}_{m} = 0\end{matrix} \}$$
setting constant coefficients
$$\begin{matrix}{A}_{0} = det [ \begin{matrix}{I}_{F} & {I}_{W} \\ {C}_{F} & {C}_{W}\end{matrix} ] ; {A}_{n} = det [ \begin{matrix}{I}_{F} & {I}_{n} \\ {C}_{F} & {C}_{n}\end{matrix} ] ; \\ {A}_{m} = det [ \begin{matrix}{I}_{F} & {I}_{m} \\ {C}_{F} & {C}_{m}\end{matrix} ] ; {A}_{n m} = det [ \begin{matrix}{I}_{F} & {I}_{n m} \\ {C}_{F} & {C}_{n m}\end{matrix} ] . \\ {B}_{0} = det [ \begin{matrix}{I}_{F} & {I}_{W} \\ {S}_{F} & {S}_{W}\end{matrix} ] ; {B}_{n} = det [ \begin{matrix}{I}_{F} & {I}_{n} \\ {S}_{F} & {S}_{n}\end{matrix} ] ; \\ {B}_{m} = det [ \begin{matrix}{I}_{F} & {I}_{m} \\ {S}_{F} & {S}_{m}\end{matrix} ] ; {B}_{n m} = det [ \begin{matrix}{I}_{F} & {I}_{n m} \\ {S}_{F} & {S}_{n m}\end{matrix} ] .\end{matrix}$$
by the values of the 2×2 matrixes determinants, compiled from the ICaS color space coordinates, where the first column is given by the F color coordinates (index F), the second column is given by the coordinates of 4 base vectors, in particular, the paper (index W), two colored inks (indices n and m), and their mutual overlapping (index nm) and calculating required amount σ_{K} of third black ink (K) for reproducing of the selected color F_{ICaS} by the size of the achromatic coordinate I_{F} of the original color using the formula:
$${σ}_{K} = \frac{{I}_{F}^{( 2 )} - {I}_{F}}{{I}_{F}^{( 2 )}} ,$$
which takes into account value of the achromatic component of the color F, and is formed by two adjacent colored inks,
I_{F}⁽²⁾=I_{W}(1−σₙ)(1−σₘ)+Iₙσₙ(1−σₘ)+Iₘσₘ(1−σₙ)+Iₙₘσₙσₘ,
forming the N channels of color separated images for colored inks and common channel of the separated image for the black ink.

2. Method according to claim 1, in which transformation of original digital image into coordinates of the ICaS opponent color space of the imprint is carried out in the form of a decomposition to the base vectors F_{W} of paper, Fₙ of the colored inks and vectors Fₙₘ, Fₙₘₗ of their mutual overlapping on the imprint.
$$F = ( 1 - {σ}_{K} ) \{ ( 1 - {σ}_{C} ) ( 1 - {σ}_{M} ) ( 1 - {σ}_{Y} ) {F}_{W} + {σ}_{C} {σ}_{M} {σ}_{Y} {F}_{CMY} + {σ}_{C} ( 1 - {σ}_{M} ) ( 1 - {σ}_{Y} ) {F}_{C} + ( 1 - {σ}_{C} ) {σ}_{M} ( 1 - {σ}_{Y} ) {F}_{M} + ( 1 - {σ}_{C} ) ( 1 - {σ}_{M} ) {σ}_{Y} {F}_{Y} + {σ}_{C} {σ}_{M} ( 1 - {σ}_{Y} ) {F}_{CM} + {σ}_{C} {σ}_{Y} ( 1 - {σ}_{M} ) {F}_{CY} + {σ}_{M} {σ}_{Y} ( 1 - {σ}_{C} ) {F}_{MY} \}$$

3. Method according to claim 1, in which during transformation into the ICaS opponent color space of the imprint all colors of original characterized by achromatic coordinate I_{F} and two chromatic coordinates (C_{F},S_{F}) on trial impression of color coordinates (L*,a*,b*) with 2N patches of colored inks control scales.

4. Method according to claim 1, in which each pixel of the original digital image in the opponent color space of the imprint is separated only into three inks—two adjacent colored inks which on a chromatic CaS-diagram are determined by the chromatic coordinates (C_{F},S_{F}) of the original color, and form in the printing process the color characteristics of the image on the imprint with a minimum amount of colored and third black (K) inks, which is determined by the achromatic coordinate I_{F} of the original color and forms the achromatic axis of the color gamut of the image on the imprint.

5. Method according to claim 4, in which with the traditional four-color CMYK printing, in the process of the image separation into two color and black (K) inks, all colors F of the original image are divided into three groups according to their location at the sectors of paired overlapping of the two colored inks C+M, M+Y, and Y+C, respectively.

6. Method according to claim 5, at which in the first sector, which is bounded by the lines of the cyan (C) and magenta (M) base vectors, all the colors that form the blue region of the original image are taken, this color region is colorimetric accurately reproduced on the imprint by three inks—cyan (C), magenta (M) and black (K).

7. Method according to claim 5, at which in the second sector, which is bounded by the base vectors of the magenta (M) and yellow (Y) inks, similarly all the colors that form the red region of the original image are selected, this color region is colorimetric accurately reproduced on the imprint by three inks—magenta (M), yellow (Y) and black (K).

8. Method according to claim 5, at which in the third sector, which is bounded by the basic vectors of the yellow (Y) and cyan (C) inks, all colors that form the green region of the original image are selected, this color region is colorimetric accurately reproduced on the imprint by three inks—yellow (Y), cyan (C) and black (K).
